(19) United States
(12) Patent Application Publication
(10) Pub. No.: US 2019/0354154 A1
(43) Pub. Date: Nov. 21, 2019

(54) INDUCTORS

(71) Applicant: Hewlett Packard Enterprise Development LP, Houston, TX (US)

(72) Inventors: Kirk Yates, Houston, TX (US); Mohamed Amin Bemat, Cypress, TX (US); Christopher L. Culpepper, Houston, TX (US)

(21) Appl. No.: 15/983,222

(22) Filed: May 18, 2018

(51) Int. Cl. G06F 1/28; G05F 1/56; G06F 1/26

(52) U.S. Cl. CPC G06F 1/28; G06F 1/263; G05F 1/56

(57) ABSTRACT

Inductors are described herein. In one example, an inductor can include a first lead positioned on a first side of the inductor to couple the inductor to a first circuit that includes a power supply for a second circuit, and a second lead positioned on a second side of the inductor to couple the inductor to the second circuit to provide electrical power from the power supply to electrical components coupled to the second circuit.

### BACKGROUND

Inductors can be termed coils, chokes, or reactors. Inductors can be a passive two-terminal electrical component that can store electrical energy in a magnetic field when electric current flows through the inductor. In some examples, an inductor can oppose a change in current that is flowing through the inductor. In some examples an inductor can have a particular inductance, which can be a ratio of voltage to a rate of change in the current.

### BRIEF DESCRIPTION OF THE DRAWINGS

FIG. 1 illustrates an example device for an inductor consistent with the present disclosure.

FIG. 2 illustrates an example system for an inductor consistent with the present disclosure.

FIG. 3 illustrates an example system that includes a plurality of inductors consistent with the present disclosure.

FIG. 4 illustrates an example system that includes a plurality of inductors consistent with the present disclosure.

FIG. 5 illustrates an example system that includes a single inductor consistent with the present disclosure.

### DETAILED DESCRIPTION

An inductor can be a device or circuit that includes inductance. As used herein, inductance includes an electromotive force that is generated by a change in electrical current. The inductance can be utilized to oppose changes in electrical current. Inductors described herein can be utilized to couple a first circuit assembly to a second circuit assembly by including a first lead positioned on a first side of the inductor and a second lead positioned on a second side of the inductor. In this way, the first circuit assembly can be positioned above the second circuit assembly to provide additional cooling for the first circuit assembly. For example, an inductor can include a first lead positioned on a first side of the inductor to couple the inductor to a first circuit that includes a power supply for a second circuit, and a second lead positioned on a second side of the inductor to couple the inductor to the second circuit to provide electrical power from the power supply to electrical components coupled to the second circuit.

In some examples, the inductors described herein can be utilized to provide power filtration between a first circuit assembly and a second circuit assembly. As used herein, power filtration includes receiving electrical power at an input and providing the electrical power within a particular voltage range at an output. That is, the inductors described herein can receive electrical power at an input lead that can include pulse width controlled rectangular wave voltage and filter the received electrical power to be within the voltage range that is utilized by electrical loads.

In some examples, a power supply can be coupled to the first circuit assembly to provide electrical power to a power stage coupled to the first circuit assembly. In some examples, the power stage can be coupled between the power supply and the first lead of an inductor coupled to the first circuit assembly. For example, a connector can be positioned on the first circuit assembly to couple the power supply to the first circuit assembly. In this example, the connector can be coupled to the power stage to provide electrical power to the power stage. In this example, a first lead of an inductor can be coupled to receive the electrical power from the power stage on the first circuit assembly and a second lead of the inductor can be coupled to the second circuit assembly to provide the electrical power from the power stage to the second circuit assembly. In some examples, the electrical power provided to the second circuit assembly can be filtered by the inductor and utilized to power a number of electrical components coupled to the first circuit assembly.

The inductors described herein can be utilized to couple a first circuit assembly that includes a number of electrical power connectors, electrical power connection lines, and/or pulse width modulation (PWM) controllers to a second circuit assembly. The second circuit assembly can include a number of components to be powered by the electrical power provided by the first circuit assembly through an inductor coupled between the first circuit assembly and the second circuit assembly.

In some examples, utilizing the first circuit assembly to couple the power connectors, electrical power connection lines, and/or the PWM controllers can reduce the quantity of electrical power connection lines on the second circuit assembly. In this way, the “quiet side” of the second circuit assembly can be increased, which can lower a level of noise on the second circuit assembly. In addition, utilizing the first circuit assembly to couple the power connectors, electrical power connection lines, and/or the PWM controllers can provide the same impedance path as having the power connectors, electrical power connection lines, and/or the PWM controllers on the second circuit assembly.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

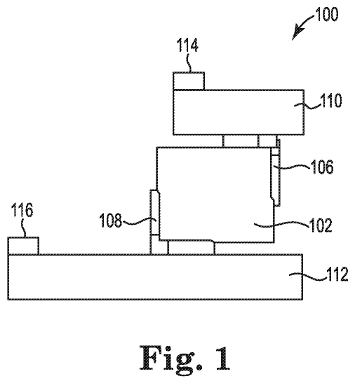

FIG. 1 illustrates an example device 100 for an inductor 102 consistent with the present disclosure. In some examples, the device 100 can include an inductor 102 that can include a first lead 106 positioned on a first side of the inductor 102 to couple the inductor 102 to a first circuit 110 that includes a power supply 114 for a second circuit 112, and a second lead 108 positioned on a second side of the inductor 102 to couple the inductor 102 to the second circuit 112 to provide electrical power from the power supply 114 to electrical components 116 coupled to the second circuit 112.

As used herein, a lead such as the first lead 106 and the second lead 108 can include an electrical connection of the inductor 102. For example, the first lead 106 can be an electrical connection to allow electrical current to enter or exit the inductor 102. Similarly, the second lead 108 can be an electrical connection to allow electrical current to enter or exit the inductor 102. In some examples, the first lead 106 and/or second lead 108 can include a conductive material. As used herein, a conductive material can include a material that allows the flow of an electrical current. For example, the first lead 106 and/or the second lead 108 can comprise a metallic material such as copper or gold.

In some examples, the device 100 can include a first circuit assembly 110 and a second circuit assembly 112. As used herein, a circuit assembly can include an electrical circuit that provides an interconnection of electrical components such as an electrical connector, a network connector, a battery, a resistor, an inductor, a capacitor, a switch, among other electrical components. In some examples, a circuit assembly can include a printed circuit board (PCB) and/or a printed circuit assembly (PCA). As used herein, a PCB and/or PCA can include a device that includes a plurality of electrical connections that can connect electrical components. In some examples, a PCB and/or a PCA can include a plurality of layers of conductive material such as copper between a plurality of layers of non-conductive material such as a polymer or plastic material.

In some examples, the inductor 102 can be utilized to provide electrical power from the first circuit assembly 110 to the second circuit assembly 112. For example, the inductor 102 can be a device that includes an inductance that can provide average DC voltage when the electrical current is passed between the first circuit assembly 110 and the second circuit assembly 112. In some examples, electrical current can be provided by the first circuit assembly 110. In these examples, the electrical current can be provided to the first lead 106 and move through the inductor 102 to the second lead 108 and be provided to the second circuit assembly 112. In some examples, the electrical current provided to the second circuit assembly 112 through the inductor 102 can provide electrical current to a number of components 116 coupled to the second circuit assembly 112. For example, the second circuit assembly 112 can be a main board of a computing device or computing system that includes a number of processing resources, memory resources, and/or other components.

In some examples, the inductor 102 can be utilized to provide electrical power from the first circuit assembly 110 to the second circuit assembly 112. For example, an electrical current provided to the power supply 114 of the first circuit assembly 110 can be provided to the first lead 110, through the inductor 102 to the second lead 108, and provided to the components 116 of the second circuit assembly 112. In this example, the inductor 102 can be utilized to maintain a current level when the electrical current is transferred from the first circuit assembly 110 to the second circuit assembly 112.

In some examples, the inductor 102 can be utilized to maintain the voltage level for functional operation of the components 116 of the second circuit assembly 112. For example, components 116 of the second circuit assembly 112 may not function if the voltage level is out of a specified range. In some examples, the power supply 114 can be a power supply connector that is positioned on the first circuit assembly 110 to receive electrical power from a remote power supply. In some examples, the power supply 114 can be coupled to a power stage on the first circuit assembly 110. As used herein, a power stage can be a device that performs a power conversion utilizing a switching mechanism. In some examples, the power stage can be part of a voltage regulator down module. In some examples, the first circuit assembly 110 can include a voltage regulator down (VRD) for the second circuit assembly 112. As used herein, a VRD can include a converter that can convert a first voltage to a second voltage that is lower than the first voltage.

In some examples, the switching mechanism can include turning one or more switches between a power supply 114 and an inductor 102. In some examples, the power stage can transform a first voltage to a second voltage. For example, the power supply 114 can supply a first voltage to an input of the power stage and the power stage can output a second voltage to the first lead 106 of the inductor 102. In some examples, inductor 102 can prevent current spikes generated by the power stage transforming the first voltage to the second voltage.

In some examples, the inductor 102 can include a first lead 106 positioned on a first side of the inductor 102 (e.g., top side as illustrated in FIG. 1) to couple the inductor 102 to a first circuit assembly 110, and a second lead 108 positioned on a second side of the inductor 102 (e.g., bottom side as illustrated in FIG. 1) to couple the inductor 102 to a second circuit assembly 112. In some examples, the inductor 102 can include a first lead 106 positioned on a side of the inductor 102 that is opposite of the second lead 108. For example, the first lead 106 can be positioned on a first corner or edge of the inductor 102 (e.g., upper right corner of the inductor 102 as illustrated in FIG. 1) and the second lead 108 can be positioned on a second corner or edge of the inductor (e.g., lower left corner of the inductor 102 as illustrated in FIG. 1) that is opposite of the corner of the first lead 106.

In some examples, a position of the first lead 106 and the second lead 108 can be utilized to stack the first circuit assembly 110 and the second circuit assembly 112. For example, the position of the first lead 106 can allow the inductor 102 to be coupled to the first circuit assembly 110 positioned on a first side of the inductor 102 (e.g., top side as illustrated in FIG. 1). In this example, the position of the second lead 108 can allow the inductor 102 to be coupled to the second circuit assembly 112 positioned on a second side of the inductor 102 (e.g., bottom side as illustrated in FIG. 1).

In some examples, the first circuit assembly 110 can be positioned at a first level or height and the second circuit assembly 112 can be positioned at a second level or height that is different than the first height. For example, the second circuit assembly 112 can be positioned below the first circuit assembly 110 at a distance of a height of the inductor 102. That is, the inductor 102 can be positioned between the first circuit assembly 110 and the second circuit assembly 112. In some examples, positioning the first circuit assembly 110 above the second circuit assembly 112 can provide additional cooling resources to the first circuit assembly 110. For example, the first circuit assembly 110 can be positioned above the second circuit assembly 112 to receive cool air flowing over the first circuit assembly 110. In some examples, other components of the device 100 can block cool air flowing at a level or position of the second circuit assembly 112, but can be received by the first circuit assembly 110 when the first circuit assembly 110 is positioned above the second circuit assembly 112.

In some examples, the inductor 102 can be coupled to the first circuit assembly 110 by the first lead 106 and coupled to the second circuit assembly 112 by the second lead 108. In some examples, the first circuit assembly 110 can be positioned substantially parallel to the second circuit assembly 112 when the inductor 102 is coupled to the first circuit assembly 110 and the second circuit assembly 112. As used herein, substantially parallel can be a position that is more parallel than perpendicular.

As described herein, the inductor 102 can include a first lead 106 and a second lead 108 that are positioned on opposite sides of the inductor 102 to couple a first circuit assembly 110 above a second circuit assembly 112. The inductor 102 can be utilized to provide electrical power from the first circuit assembly 110 to the second circuit assembly 112. In some examples, positioning the first circuit assembly 110 above the second circuit assembly 112 can provide additional cooling resources to the first circuit assembly 110. In addition, the first circuit assembly 110 can be utilized to couple electrical components such as a power supply 114 and/or a power stage, which can reduce noise on the second circuit assembly 112.

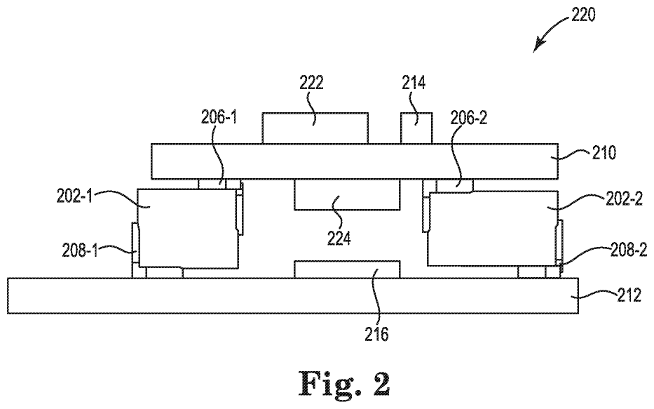

FIG. 2 illustrates an example system 220 for an inductor consistent with the present disclosure. In some examples, the system 220 can include the same or similar elements as device 100 as illustrated in FIG. 1. For example, the system 220 can include a first circuit assembly 210 and a second circuit assembly 212.

As described herein, the second circuit assembly 212 can be a main circuit assembly for a computing device and the first circuit assembly 210 can be a sub-assembly or a non-main circuit assembly. As used herein, a main circuit assembly can include a PCB or PCA that includes a main processing resource such as a central processing unit (CPU). As used herein, a sub-assembly or non-main circuit assembly can include a PCB or PCA that does not include the main processing resource of the computing device.

In some examples, the system 220 can include a first inductor 202-1 that includes a first lead 206-1 coupled to the first circuit assembly 210 and a second lead 208-1 coupled to the second circuit assembly 212. In addition, the system 220 can include a second inductor 202-2 that includes a first lead 202-2 coupled to the first circuit assembly 210 and a second lead 208-2 coupled to the second circuit assembly 212. In some examples, the system 220 can include a power supply 214 coupled to the first circuit assembly 210. As described herein, the power supply 214 can be coupled to the first circuit assembly 210 through a connector that is positioned on the first circuit assembly 210. In some examples, the power supply 214 can provide electrical power to the first circuit assembly 210 through a connector soldered to the first circuit assembly 210. In some examples, the first inductor 202-1 can be a power filter for a first component of the number of components 216 coupled to the second circuit assembly 214 and the second inductor 202-2 can be a power filter for a second component of the number of components 216 coupled to the second circuit assembly.

In some examples, the system 220 can include a power stage 222 coupled to the first circuit assembly 210. For example, the power stage 222 can be positioned on the first circuit assembly 210. In this example, the power stage 222 can be coupled or soldered to the first circuit assembly 210. In some examples, the power stage 222 can be coupled to the power supply 214 to receive electrical power from the power supply 214. As described herein, the power stage 222 can be a device that performs a power conversion utilizing a switching mechanism. As described herein, the power stage 222 can be part of a voltage regulator down (VRD) to convert an input power with a first voltage to an output power with a second voltage that is a lower voltage than the first voltage.

As used herein, a power conversion includes receiving an input voltage and converting the input voltage to an output voltage that is different than the input voltage. For example, the power stage 222 can convert an input of 12 Volts (V) to an output of 1.8 V. In some examples, the power stage 222 can be a direct current (DC) to DC converter that utilizes a switching mechanism to convert the input power received by the power supply 214 to an output power that can be utilized by components 216 of the second circuit assembly 212.

In some examples, a switching mechanism can include turning one or more switches between a power supply 214 and an inductor such as the first inductor 202-1 and the second inductor 202-2. In some examples, the output power is provided to the first lead 206-1 of the first inductor 202-1 and/or provided to the first lead 206-2 of the second inductor 202-2. As described herein, the first inductor 202-1 and the second inductor 202-2 can include an inductance that can oppose a change in current. For example, the first inductor 202-1 and the second inductor 202-2 can store and release energy from a magnetic field that opposes a change in current. In this way, the stored energy is utilized to provide regulated average DC voltage to the components 216 coupled to the second circuit assembly 212.

In some examples, the first inductor 202-1 and second inductor 202-2 can provide power pass through from the first circuit assembly 210 to the second circuit assembly 212. As used herein, power pass through can include a power storage device like a battery that can be charged at the same time as charging or providing power to a different device of the components 216.

In some examples, the system 220 can include a pulse width modulation (PWM) controller 224 coupled to a driver of the power stage 222. In some examples, the PWM controller 224 can be utilized to control a voltage and/or current provided to a load such as the components 216 by the power stage 222. For example, the driver of the power stage 222 can alter a frequency of the rectangular input voltage to the inductor 206-1 to alter a voltage output and/or current output of the DC to DC converter. In some examples, the switching input to the inductor 206-1, 206-2 produced by the power stage 222 can include turning one or more switches between a power supply and an inductor 206-1, 206-2. For example, the power stage 222 can include a plurality of switches that alter between the power supply 214 and the first lead 206-1 of the first inductor 202-1 and/or the first lead 206-2 of the second inductor 202-2.

In some examples, the electrical power received at the first lead 206-1 of the first inductor 202-1 can move through the first inductor 202-1 to the second lead 208-1. In these examples, the electrical power can be provided to the second circuit assembly 212 through the second lead 208-1 of the first inductor 202-1 to provide the electrical power to the components 216 coupled to the second circuit assembly 212. As described herein, the components 216 of the second circuit assembly 212 can include processing resources such as a central processing unit, memory resources such as a solid state drive (SSD), and/or other components of a computing device. In some examples, the components 216 can each utilize a specific voltage for functional operation. In this way, the first inductor 202-1 and the second inductor 202-2 can be utilized to maintain a DC voltage level within a threshold value of the components 216.

In some examples, a position of the first lead 206-1, 206-2 and the second lead 208-1, 208-2 can be utilized to stack the first circuit assembly 210 and the second circuit assembly 212. For example, the position of the first lead 206-1 can allow the first inductor 202-1 to be coupled to the first circuit assembly 210 positioned on a first side of the first inductor 202-1 (e.g., top side as illustrated in FIG. 2). In this example, the position of the second lead 208-1 can allow the first inductor 202-1 to be coupled to the second circuit assembly 212 positioned on a second side of the first inductor 202-1 (e.g., bottom side as illustrated in FIG. 2).

In some examples, the first circuit assembly 210 can be positioned at a first level or height and the second circuit assembly 212 can be positioned at a second level or height that is different than the first height. For example, the second circuit assembly 212 can be positioned below the first circuit assembly 210 at a distance of a height of the inductors 202-1, 202-2. That is, the first inductor 202-1 and the second inductor 202-2 can be positioned between the first circuit assembly 210 and the second circuit assembly 212. In some examples, positioning the first circuit assembly 210 above the second circuit assembly 212 can provide additional cooling resources to the first circuit assembly 210. For example, the first circuit assembly 210 can be positioned above the second circuit assembly 212 to receive cool air flowing over the first circuit assembly 210. In some examples, other components of the system 220 can block cool air flowing at a level or position of the second circuit assembly 212, but can be received by the first circuit assembly 210 when the first circuit assembly 210 is positioned above the second circuit assembly 212.

As described herein, the inductors 202-1, 202-2 can include a first lead 206-1, 206-2 and a second lead 208-1, 208-2 that are positioned on opposite sides of the inductors 202-1, 202-2 respectively to couple a first circuit assembly 210 above a second circuit assembly 212. The inductors 202-1, 202-2 can be utilized to provide electrical power from the first circuit assembly 210 to the second circuit assembly 212. In some examples, positioning the first circuit assembly 210 above the second circuit assembly 212 can provide additional cooling resources to the first circuit assembly 210. In addition, the first circuit assembly 210 can be utilized to couple electrical components such as a power supply 214 and/or a power stage 222, which can reduce noise on the second circuit assembly 212.

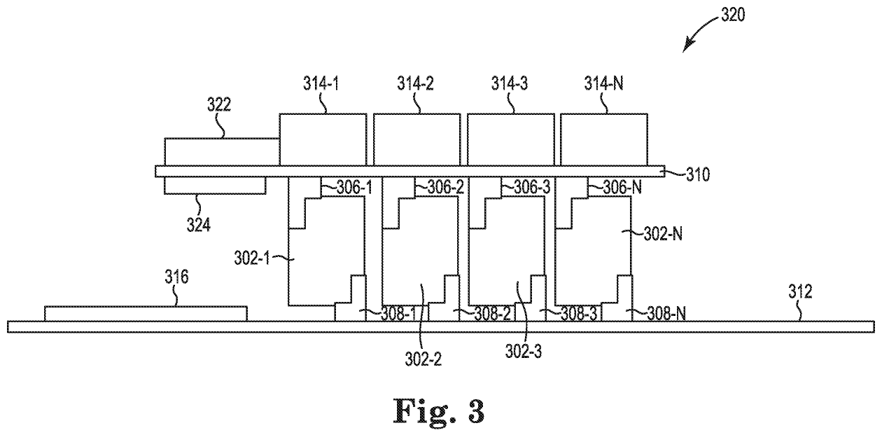

FIG. 3 illustrates an example system 320 that includes a plurality of inductors 302-1, 302-2, 302-3, 302-N consistent with the present disclosure. As used herein, the designated “N” can represent a numerical digit to illustrate that a plurality of additional corresponding elements can be utilized without departing from the disclosure. In some examples, the system 320 can include the same or similar elements as device 100 as referenced in FIG. 1 and/or similar elements as system 220 as referenced in FIG. 2. For example, the system 320 can include a first circuit assembly 310 and a second circuit assembly 312 separated by the plurality of inductors 302-1, 302-2, 302-3, 302-N. As described herein, the first circuit assembly 310 can be a sub-assembly of the computing device and the second circuit assembly 312 can be a main circuit assembly for the computing device.

In some examples, the second circuit assembly 312 can include a number of components 316 that can utilize electric power (e.g., electricity). In some examples, the number of components 316 can provide a system load for the computing device. For example, the number of components 316 can include, but are not limited to: processing resources, central processing units, memory resources, application specific integrated circuits (ASICs), and/or other electrical components of a computing device. In some examples, the number of components 316 can utilize a electrical power within a voltage range and/or a current range. For example, the number of components 316 can utilize a voltage range between 1.5 V and 2.0 V. In another example, the number of components 316 can utilize a current range between 200 A and 400 A.

In some examples, the system 320 can include a plurality of power supplies 314-1, 314-2, 314-3, 314-N coupled to the first circuit assembly 310. As described herein, the plurality of power supplies 314-1, 314-2, 314-3, 314-N can include electrical connectors that are coupled to the first circuit assembly 310. For example, the plurality of power supplies 314-1, 314-2, 314-3, 314-N can provide electrical power to the first circuit assembly 310 through a plurality of corresponding connectors that are soldered to the first circuit assembly 310. In some examples, the plurality of power supplies 314-1, 314-2, 314-3, 314-N can each provide electrical power at a first voltage and current level. For example, the plurality of power supplies 314-1, 314-2, 314-3, 314-N can each provide 12 V and 40 A.

In some examples, each of the plurality of power supplies 314-1, 314-2, 314-3, 314-N can be coupled to a corresponding first lead 306-1, 306-2, 306-3, 306-N of a corresponding inductor 302-1, 302-2, 302-3, 302-N to transfer the electrical power to a corresponding second lead 308-1, 308-2, 308-3, 308-N that can be received at a corresponding location of the second circuit assembly 312. For example, the power supply 314-1 can be coupled to the first lead 306-1 of the inductor 302-1 to transfer power to the second lead 308-1 that is coupled to the second circuit assembly 312 to provide electrical power to the number of components 316.

In some examples, the system 320 can include a power stage 322 coupled to the first circuit assembly 310. For example, the power stage 322 can be positioned on the first circuit assembly 310. In this example, the power stage 322 can be soldered to the first circuit assembly 310. In some examples, the power stage 322 can be coupled to the plurality of power supplies 314-1, 314-2, 314-3, 314-N to receive electrical power from the plurality of power supplies 314-1, 314-2, 314-3, 314-N. In some examples, each of the plurality of power supplies 314-1, 314-2, 314-3, 314-N can be coupled to a corresponding power stage 322. As described herein, the power stage 322 can be a device that performs a power conversion utilizing a switching mechanism.

In some examples, the system 320 can include a pulse width modulation (PWM) controller 324 coupled to a driver of the power stage 322. In some examples, the PWM controller 324 can be utilized to control a voltage provided to a load such as the components 316 by the power stage 322. For example, the driver of the power stage 322 can alter a frequency of the switching rectangular input voltage to the inductors 302-1, 302-2, 302-3, 302-N to alter a voltage output and/or current output of DC to DC converter. In some examples, the switching input to the inductor produced by the power stage 322 can include turning one or more switches between a power supply and an inductor of the plurality of inductors 302-1, 302-2, 302-3, 302-N. For example, the power stage 322 can include a plurality of switches that alter between the power supply 314-1 and the first lead 306-1 of the first inductor 302-1. In some examples, the PWM controller 324 can be coupled to a corresponding driver of each of a plurality of power stages 322 for each of the plurality of power supplies 314-1, 314-2, 314-3, 314-N.

As described herein, the inductors 302-1, 302-2, 302-3, 302-N can include conductive leads that are positioned on opposite sides of the inductors 302-1, 302-2, 302-3, 302-N respectively to couple a first circuit assembly 310 above a second circuit assembly 312. The inductors 302-1, 302-2, 302-3, 302-N can be utilized to provide electrical power from the first circuit assembly 310 to the second circuit assembly 312. In some examples, positioning the first circuit assembly 310 above the second circuit assembly 312 can provide additional cooling resources to the first circuit assembly 310. In addition, the first circuit assembly 310 can be utilized to couple electrical components such as the plurality of power supplies 314-1, 314-2, 314-3, 314-N and/or the power stage 322, which can reduce noise on the second circuit assembly 312.

Furthermore, the first circuit assembly 310 can be utilized to couple a greater quantity of electrical components compared to examples having the plurality of power supplies 314-1, 314-2, 314-3, 314-N and/or the power stage 322 coupled to the second circuit assembly 312. For example, there can be limited space for components 316 and the plurality of power supplies 314-1, 314-2, 314-3, 314-N when the plurality of power supplies 314-1, 314-2, 314-3, 314-N can create noise for the components 316 on the second circuit assembly 312.

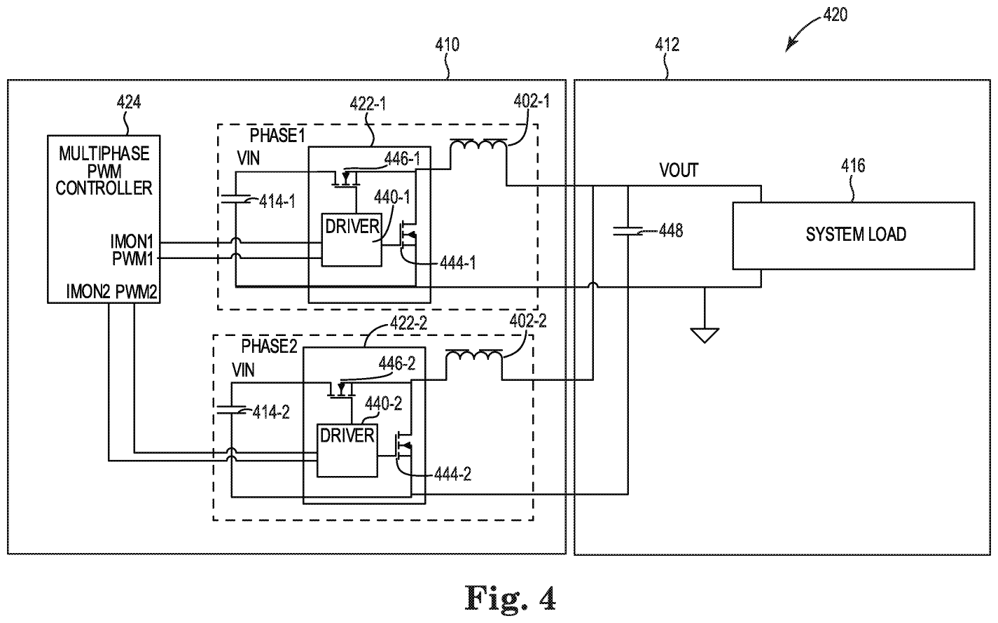

FIG. 4 illustrates an example system 420 that includes a plurality of inductors 402-1, 402-2 consistent with the present disclosure. FIG. 4 can illustrate a multi-phase system 420. FIG. 4 can illustrate a schematic representation of the device 100 as referenced in FIG. 1, system 220 as referenced in FIG. 2, and/or system 320 as referenced in FIG. 3. In some examples, FIG. 4 can be a system 420 that includes a first circuit assembly 410 coupled to a second circuit assembly 412 by the plurality of inductors 402-1, 402-2. As described herein, the first circuit assembly 410 can be positioned above the second circuit assembly 412 to provide additional air cooling resources to the first circuit assembly 410.

In some examples, the system 420 can include a first power supply 414-1 and a second power supply 414-2. In some examples, the first power supply 414-1 and/or the second power supply 414-2 can be electrical connectors that can be coupled to a remote power source (e.g., direct current source, etc.). For example, the first power supply 414-1 and/or the second power supply 414-2 can be an electrical connector that is coupled to a power converter that converts electrical power from an electrical grid to 12 V DC. That is, the first power supply 414-1 and/or the second power supply 414-2 can be a source location for 12 V DC electrical power.

In some examples, the first power supply 414-1 can be coupled to a first power stage 422-1. In some examples, the second power supply 414-2 can be coupled to a second power stage 422-2. In some examples, the first power stage 422-1 and/or the second power stage 422-2 can be metal oxide semiconductor field effect transistor (MOSFET) power stages. As described herein, the first power stage 422-1 and/or the second power stage 422-2 can be utilized to convert an input voltage or input current from a power supply to an output voltage or output current that is different than the input voltage or input current.

For example, the input voltage and input current from the power supply 414-1 can be received by the power stage 422-1. In this example, the power supply 414-1 can provide 12 V DC and 40 Amps DC to the power stage 422-1. In this example, the power stage can utilize a switching mechanism to convert the provided electrical power to 1.8 V DC and 200 Amps DC. In this example, the system load 416 can receive the converted electrical power through the inductor 402-1, which can prevent or oppose a change in the current of the provided electrical power.

In some examples, the first power stage 422-1 and/or the second power stage 422-2 can utilize a switching mechanism to convert electrical power received from a power source (e.g., power supply 414-1, power supply 414-2, etc.). For example, the first power stage 422-1 can include a first switch 444-1 and a second switch 446-1 coupled to a driver 440-1. In this example, the driver 440-1 can be coupled to a multiphase pulse width modulation (PWM) controller 424. In another example, the power stage 422-2 can include a first switch 444-2 and a second switch 446-2 coupled to a driver 440-2. In this example, the driver 440-2 can be coupled to a multiphase pulse width modulation (PWM) controller 424.

In some examples, the driver 440-1 can be utilized to activate and deactivate the first switch 444-1 and the second switch 446-1 at a particular frequency. For example, the driver 440-1 can alternate the activation and deactivation of the first switch 444-1 and the second switch 446-1 at a particular frequency to generate a particular waveform that can generate a corresponding output voltage and output current. In some examples, the multiphase PWM controller 424 can provide instructions to the driver 440-1 to alter the frequency based on the system load 416. In another example, the multiphase PWM controller 424 can provide instructions to the driver 440-2 to alternate the activation and deactivation of the switches 444-2, 446-2 at a particular frequency based on the system load 416.

In some examples, the converted output power from the first power stage 422-1 can be provided to a lead of a first inductor 402-1 and the converted output power from the second power stage 422-2 can be provided to a lead of a second inductor 402-2. In some examples, the electrical power provided by the first power stage 422-1 to the first inductor 402-1 can be provided to the system load 416 to provide electrical power to the electrical components that make up the system load 416. In another example, the electrical power provided by the second power stage 422-2 to the second inductor 402-2 can be provided to the system load 416. In some examples, the electrical power provided through the first inductor 402-1 can be utilized to provide electrical power to a first portion of the system load 416 and the electrical power provided through the second inductor 402-2 can be utilized to provide electrical power to a second portion of the system load 416.

The system 420 can include a first circuit assembly 410 that includes electrical connectors and/or electrical conductive lines for power supplies 414-1, 414-2, a multiphase PWM controller 424, and/or power stages 422-1, 422-2. In this way, the first circuit assembly 410 can remove noise from the second circuit assembly 412. In some examples, the noise created by electrical connections or electrical conductive lines can interfere with communication lines. In this way, the first circuit assembly 410 can remove noise from the second circuit assembly 412, which can increase a “quiet area” of the second circuit assembly 412. As used herein, the “quiet area” can be an area where communication lines can be positioned with a noise level below a threshold that can affect communication being transferred through the communication lines. Thus, the system 420 can be utilized to increase the “quiet area” of the second circuit assembly 412 to allow additional components to be positioned on the second circuit assembly 412.

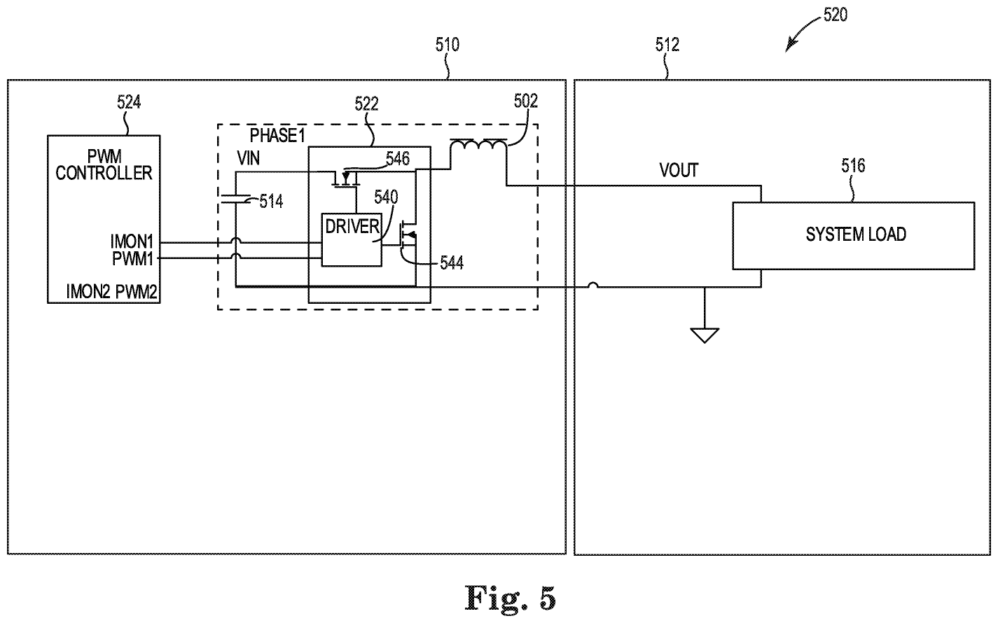

FIG. 5 illustrates an example system 520 that includes a single inductor 502 consistent with the present disclosure. FIG. 5 can illustrate a single-phase system 520. FIG. 5 can illustrate a schematic representation of the device 100 as referenced in FIG. 1, system 220 as referenced in FIG. 2, system 320 as referenced in FIG. 3, and/or system 420 as illustrated in FIG. 4. In some examples, FIG. 5 can be a system 520 that includes a first circuit assembly 510 coupled to a second circuit assembly 512 by the inductor 502. As described herein, the first circuit assembly 510 can be positioned above the second circuit assembly 512 to provide additional air cooling resources to the first circuit assembly 510.

In some examples, the system 520 can include a power supply 514. In some examples, the power supply 514 can be an electrical connector that can be coupled to a remote power source (e.g., direct current source, etc.). For example, the power supply 514 can be an electrical connector that is coupled to a power converter that converts electrical power from an electrical grid to 12 V DC. That is, the power supply 514 can be a source location for 12 V DC electrical power.

In some examples, the power supply 514 can be coupled to a power stage 522. In some examples, the power stage 522 can be a metal oxide semiconductor field effect transistor (MOSFET) power stage. As described herein, the power stage 522 can be utilized to convert an input voltage or input current from a power supply to an output voltage or output current that is different than the input voltage or input current.

For example, the input voltage and input current from the power supply 514 can be received by the power stage 522. In this example, the power supply 514 can provide 12 V DC and 6 Amps DC to the power stage 522. In this example, the power stage 522 can utilize a switching mechanism to convert the provided electrical power to 1.8 V DC and 35 Amps DC. In this example, the system load 516 can receive the converted electrical power through the inductor 502, which can prevent or oppose a change in the current of the provided electrical power.

In some examples, the power stage 522 can utilize a switching mechanism to convert electrical power received from a power source (e.g., power supply 514, etc.). For example, the power stage 522 can include a first switch 544 and a second switch 546 coupled to a driver 540. In this example, the driver 540 can be coupled to a pulse width modulation (PWM) controller 524.

In some examples, the driver 540 can be utilized to activate and deactivate the first switch 544 and the second switch 546 at a particular frequency. For example, the driver 540 can alternate the activation and deactivation of the first switch 544 and the second switch 546 at a particular frequency to generate a particular waveform that can generate a corresponding output voltage and output current. In some examples, the PWM controller 524 can provide instructions to the driver 540 to alter the frequency based on the system load 516.

In some examples, the converted output power from the power stage 522 can be provided to a lead of the inductor 502. In some examples, the electrical power provided by the power stage 522 to the inductor 502 can be provided to the system load 516 to provide electrical power to the electrical components that make up the system load 516.

The system 520 can include a first circuit assembly 510 that includes electrical connectors and/or electrical conductive lines for a power supply 514, a PWM controller 524, and/or a power stage 522. In this way, the first circuit assembly 510 can remove noise from the second circuit assembly 512. In some examples, the noise created by electrical connections or electrical conductive lines can interfere with communication lines. In this way, the first circuit assembly 510 can remove noise from the second circuit assembly 512, which can increase a “quiet area” of the second circuit assembly 512. Thus, the system 520 can be utilized to increase the “quiet area” of the second circuit assembly 512 to allow additional components to be positioned on the second circuit assembly 512.

The above specification, examples and data provide a description of the devices, systems, applications, and use of the systems devices of the present disclosure. Since many examples can be made without departing from the spirit and scope of the system and method of the present disclosure, this specification merely sets forth some of the many possible example configurations and implementations.

What is claimed:

1. An inductor, comprising:
a first lead positioned on a first side of the inductor to couple the inductor to a first circuit that includes a power supply for a second circuit; and
a second lead positioned on a second side of the inductor to couple the inductor to the second circuit to provide electrical power from the power supply to electrical components coupled to the second circuit.

2. The inductor of claim 1, wherein the first circuit includes a pulse width modulation (PWM) controller coupled to a driver.

3. The inductor of claim 1, wherein a power stage is coupled between the power supply and the first lead of the inductor.

4. The inductor of claim 1, wherein the electrical components of the second circuit includes a central processing unit (CPU) for a computing device.

5. The inductor of claim 1, wherein the first circuit includes a voltage regulator down (VRD) for the second circuit.

6. The inductor of claim 1, wherein the first circuit is a printed circuit board (PCB) positioned on the first side of the inductor and the second circuit is a PCB positioned on the second side of the inductor.

7. The inductor of claim 1, wherein the first circuit includes a switch node that includes a metal-oxide-semiconductor field-effect transistor (MOSFET) coupled to a driver.

8. A device, comprising:
a first inductor comprising:
a first lead coupled to a first circuit assembly on a first side, wherein the first circuit assembly includes a first power supply coupled to the first lead; and
a second lead coupled to a second circuit assembly on a second side of the first inductor to provide electrical power from the first power supply to a first component coupled to the second assembly; and
a second inductor comprising:
a third lead coupled to the first circuit assembly on the first side, wherein the first circuit assembly includes a second power source coupled to the third lead; and
a fourth lead coupled to the second circuit assembly on the second side to provide electrical power from the second power source to a second component coupled to the second circuit assembly.

9. The device of claim 8, wherein second circuit assembly is a main circuit board of a computing device and the first circuit assembly is a sub-assembly board of the computing device.

10. The device of claim 8, comprising a multiphase pulse width modulation (PWM) controller coupled to a first power stage and a second power stage.

11. The device of claim 10, wherein the first power stage is coupled to the first lead of the first inductor and the second power stage is coupled to the third lead of the second inductor.

12. The device of claim 8, wherein the first inductor is a power filter for the first component coupled to the second assembly and the second inductor is power filter for the second component coupled to the second assembly.

13. The device of claim 8, wherein the first inductor and second inductor provide power pass through from the first circuit assembly to the second circuit assembly.

14. The device of claim 8, comprising:
a first power stage coupled to the first power supply to perform a switching mechanism on received electrical power from the first power supply; and
a second power stage coupled to the second power supply to perform a switching mechanism on received electrical power from the second power supply.

15. A system, comprising:
a first circuit assembly coupled to a first side of a first inductor and a first side of a second inductor;
a multiphase pulse width modulation (PWM) controller coupled to the first circuit assembly;
a first power stage coupled to the multiphase PWM and the first inductor on the first circuit assembly;
a second power stage coupled to the multiphase PWM and the second inductor on the first circuit assembly; and
a second circuit assembly coupled to a second side of the first inductor and a second side of the second inductor, wherein the first inductor and the second inductor provide power filtration from the first circuit assembly to the second circuit assembly.

16. The system of claim 15, wherein the first circuit assembly and the second circuit assembly are substantially parallel circuit assemblies.

17. The system of claim 15, comprising a first power supply coupled to the first power stage and a second power supply coupled to the second power stage.

18. The system of claim 15, comprising a system load coupled to the second circuit assembly to receive electrical power through the first inductor and the second inductor.

19. The system of claim 15, wherein first circuit assembly is positioned at a first height and the second circuit assembly is positioned at a second height that is different than the first height.

20. The system of claim 15, wherein the first power stage includes a first switching node on the first circuit assembly and the second power stage includes a second switching node on the first circuit assembly.
